(19) United States
(12) Patent Application Publication
(10) Pub. No.: US 2004/0226452 A1
(43) Pub. Date: Nov. 18, 2004

(54) Brewing apparatus with volumetric compensation for temperature changes

(76) Inventor: Lucian H. Lyall III, Coto De Caza, CA (US)

Correspondence Address: FULWIDER PATTON LEE & UTECHT, LLP, 200 OCEANGATE, SUITE 1550, LONG BEACH, CA, 90802, US

(21) Appl. No.: 10/437,088

(22) Filed: May 13, 2003

(51) Int. Cl. A47J 31/00

(52) U.S. Cl. 99/279

(57) ABSTRACT

A brewing apparatus is disclosed that polls the temperature of a water reservoir prior to initiating a brewing operation, and then adjusts the timing of a control of the valve that directs the water to a brewing compartment to account for the changes in the water's flow rate due to temperature variations of the water. Upon receipt of a command to initiate a brewing operation, a controller first commands a temperature probe to measures the bulk temperature of the heated water in the reservoir prior to a pumping operation. The probe measures the water temperature and then sends a signal to the controller reflecting the temperature of the water. The microprocessor compares the temperature of the reservoir with the nominal heated water temperature to determine if the standard filling period, i.e. valve open time, requires modification. The controller then opens and closes a flow control valve based upon the time interval value obtained in a look-up table or other means for the measured temperature. The time interval is shorter for cooler water to account for the increase flow rate cooler water experiences compared with hotter water.

### BACKGROUND OF THE INVENTION

1. Field of the Invention

The present invention relates generally to brewing apparatus such as automatic drip coffee brewing machines, and more particularly to a brewing apparatus with volumetric adjustment of brewing fluid into a brewing compartment to account for changes in flow characteristics of the brewing fluid with temperature variations that accompany subsequent brewing operations.

2. Description of Related Art

Drip coffee brewing apparatus are well known in the art. The general operation of coffee brewing apparatus involve the infusion of hot water through a piping system to be mixed with a captive quantity of coffee granules held in a filter packet or open filter compartment. The infusion of the heated water mixes with the coffee granules to release flavored oils, volatiles, and solutes held in the granules. The water and the volatiles pass through the filter to yield coffee, while the filter retains the granules for subsequent disposal. Drip coffee makers come in two basic varieties—automatic, which has a permanent water supply connected, and pour-over, which has water poured in manually. Both typically have a reservoir, a water heater, and a tube leading to a head which distributes hot water over a filter basket containing the coffee.

Unlike a percolator, in a drip coffee maker the coffee brew is not continuously boiled and percolated, but rather drips into a server such as a carafe. Drip filter machines are the most varied of all types, accommodating a large range in size and servers, from single cup models through warmed glass carafes to giant commercial models with multiple thermal carafes or heated removable servers. Different models use different techniques for distributing the hot water through the coffee and getting the right water temperature (around 95° C./200° F.) for the best flavor brew.

In an automatic coffee brewing apparatus, a water supply is connected to a heating reservoir that holds water in reserve so that heated water for brewing coffee is available on demand. Thus, a key function of the automatic coffee brewing apparatus is the maintenance of a ready supply of heated water available for brewing on command. To achieve the state of heated water on demand, a subsystem exists comprising a tank or reservoir that includes a heating element to maintain a quantity of water at a predetermined temperature. The reservoir is preferably in communication with a valve that opens and closes to an unlimited supply of water, so that water needed to fill the reservoir is always available when needed. The subsystem includes a means for detecting the level of the water, and operating the valve to introduce more water when brewing operations leave the reservoir short of its preferred quantity. A sensor detects the level of water, and when the sensor detects that the water level in the reservoir drops below a predetermined level, the sensor communicates a signal to a microprocessor that in turn opens the valve between the reservoir and the water supply. When the water level rises to the predetermined acceptable level, the sensor emits another signal to the microprocessor that operates to close the valve and terminate the feeding of water to the reservoir. In this fashion, a full supply of water is maintained in the reservoir ready for brewing.

The subsystem must also monitor the temperature of the water to maintain the reservoir at an appropriate temperature for ready brewing. Because the water from the source is preferably cool water, after each filling the reservoir must be heated to bring the temperature of mixed water back to the appropriate value, typically between 195° and 205° F. Each time water is introduced into the reservoir tank, the temperature of the water is reduced due to the influx of cooler water from the source. The temperature sensor immediately detects the drop in the temperature of the water in the reservoir, and signals the microprocessor to actuate the heating element in order to raise the temperature of the water back to the preferred value. If sufficient time lapses in between refills, then the heating element used to maintain the tank at the elevated temperature range preferred for brewing will bring the cooler water to the proper temperature before brewing. However, the heating element there is a period after the introduction of fresh cold water into the reserve tank where the temperature in the reservoir will, be lower than optimum. In the case of back to back brewing operations or multiple brewing operations in succession, the heating element will not have sufficient time to raise the water temperature to the preferred level and the brewing operation will occur with water at a lower temperature. This is referred to as the back to back brew condition. The condition is more exaggerated as successive brewing operations are repeated consecutively, where the heating element cannot catch up with the introduction of more and more cold water. Thus, in each brewing operation the temperature of the water taken from the reservoir is successively lower and lower.

With the temperature of the water lower with each successive back to back brew operation, a phenomena occurs that is not accounted for by prior art brewing apparatus. To wit, brewing machines rely on a timer to communicate the proper quantity of water from the reservoir to the brew basket to initiate the brewing operation. When a command for initiation of a brewing operation is received from a control panel, a pump in fluid communication with the heated water reservoir is actuated and a timer in the microprocessor is initiated. The timer coincides with the opening of a valve disposed between the water reservoir and the brew basket spray head where water is delivered for the brewing operation. The pump directs the heated water along a piping system that includes the operative valve controlled by the microprocessor. The pumping operation of the heated water through the valve is timed by the timer to deliver the same amount of water with each brewing operation. The valve is opened at T0, and closes at T0+X where X is the number of seconds required to fill the brew basket with the desired quantity of heated water from the reservoir. Once the timer reaches the predetermined value, the microprocessor closes the valve and shuts off the pump. This system is intended to yield a consistent quantity of water to the brew basket with each brewing operation, leading to consistent and predictable results in the brewing operation.

The problem occurs when the water in the reservoir is cooler than the preferred water temperature due to successive brewing operations, where the heating element has failed to raise the temperature of the water in the reservoir to the preferred level before the pumping operation begins. In this situation, the water in the reservoir is cooler and therefore denser, and flows faster than water at a higher temperature. The faster flowing water leads to a greater quantity of water being introduced into the brewing operation than is ordinarily expected when the temperature of the reservoir is at its optimum level. For each successive brewing operation where the temperature of the reservoir is lower and lower, more and more water is introduced into the brewing operation. This additional quantity of water due to the cooler temperature leads to unsatisfactory results, such as watered down coffee, overflow, and spillage.

The inventor is unaware of any currently existing brewing apparatus that accounts for the quantitative difference in water flow due to temperature differences after back to back brewing operations. The present invention solves the shortcomings of the prior art in a novel manner.

### SUMMARY OF THE INVENTION

The present invention is a brewing apparatus that polls the temperature of the heated water reservoir prior to initiating a brewing operation, and then adjusts the timing of a control of the valve that directs water to the brewing compartment to account for the changes in the heated water's flow rate due to temperature variations in the water. Upon receipt of a command to initiate a brewing operation, a controller such as a microprocessor communicates with a temperature probe to measures the bulk temperature of the heated water in the reservoir prior to the pumping operation. The probe measures the water temperature and then sends a signal to a microprocessor reflecting the temperature of the water. The microprocessor compares the temperature of the reservoir with the nominal heated water temperature to determine if the standard filling period, i.e. valve open time, requires modification. If the nominal temperature is sensed, then the microprocessor utilizes the standard time interval for opening the flow control valve used to direct water to the brewing station. However, if the temperature of the water in the reservoir is sensed to be lower than the nominal heated water temperature, then the microprocessor determines a new time interval for the flow control valve based upon a reading from the temperature probe. The new time interval can be obtained from a look-up table or other method to determined the reduction in amount of time the flow control valve is open relative to the standard filling period, to account for the increased flow due to the temperature difference. The offset is applied by the microprocessor to the valve control such that when cooler water is flowing through the valve, the microprocessor closes the valve sooner to prevent excess water flowing to the brewing station. In this manner, the water delivered to the brewing compartment is adjusted for temperature effects to yield a more consistent and predictable brewing operation

### BRIEF DESCRIPTION OF THE DRAWINGS

FIG. 1 is a schematic, cross-sectional view of a brewing apparatus employing the flow control of the present invention;

FIG. 2 is a chart comparing experimental data of the variation in volume of water delivered to the brewing compartment with temperature variations for a given time interval;

FIG. 3 is a flow chart of the operation of flow control for the apparatus of FIG. 1;

FIG. 4 is an example of a look-up table for the interval reduction of a pumping operation for a given temperature range; and

FIG. 5 is a chart showing the change in brew volume for successive brewing operations.

### DETAILED DESCRIPTION OF THE PREFERRED EMBODIMENTS

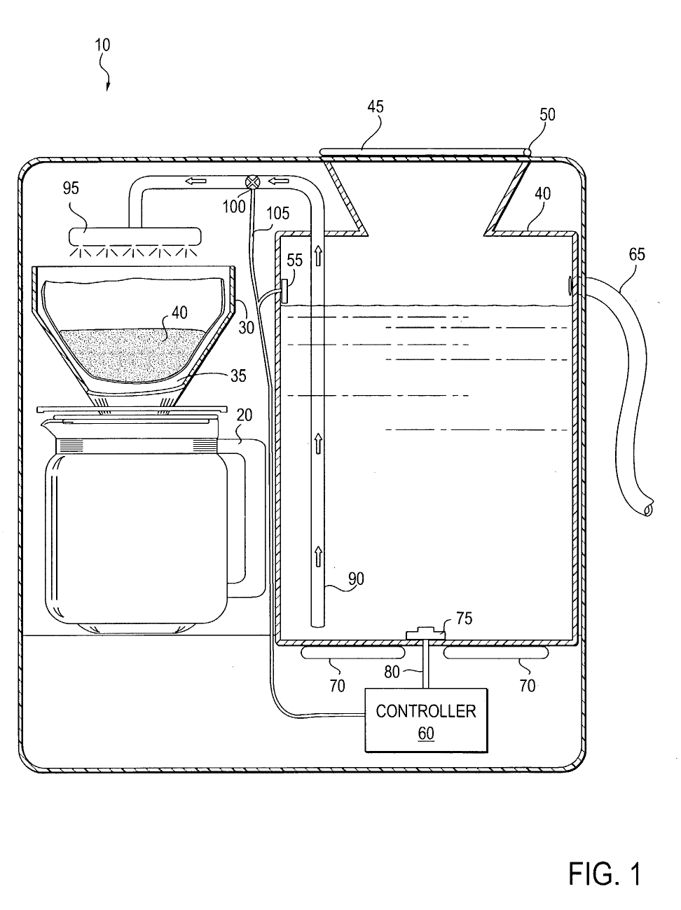

The present invention incorporates an algorithm into the logic of the brew-fill operation to adjust the filling of the brewing compartment to account for flow rate variances due to temperature effects. A schematic of a brewing apparatus incorporating the features of the present invention is shown in FIG. 1. A cut-away view of the brewing apparatus 10 shows a decanter 20 positioned below a filter basket 30 that retains a conical filter 35 and a quantity of coffee grounds 40. The filter basket 30 is positioned over the decanter 20 such that coffee that drips from the filter basket 30 falls directly into the decanter 20 where it collects until it is ready to be served.

Adjacent the decanter 20 and filter basket 30 is a reservoir 40 for holding a supply of heated water in reserve until a brewing operation is initiated, whereupon water from the reservoir 40 is directed to the filter basket 30 as described in more detail herein. The reservoir 40 may include a gate-type door 45 that pivots about a hinge 50 to provide access to the reservoir. Water can be poured manually into the reservoir 40 to replenish the water depleted from the brewing operation. Alternatively, the reservoir 40 may include an automatic refilling subsystem to replenish the water, including a water level sensor 55 that detects whether the water level is at or below a pre-selected level. If the level of the water is detected by the water level sensor to be at the pre-selected level, then no water is added to the reservoir. However, if the sensor 55 detects that the water level has fallen below the pre-selected level then the sensor sends a signal to a microprocessor or controller 60 that the water level is insufficient. The reservoir is connected to an unlimited supply of fresh water via a hose 65, where a valve (not shown) is disposed between the hose 65 and the reservoir 40. When the controller 60 receives the signal from the level sensor 55 that the water level is insufficient, the controller opens the valve to allow fresh water to flow through the hose 65 from the unlimited water supply to the reservoir 40. In this manner, a constant volume of water is maintained in the reservoir for conducting brewing operations.

Below the reservoir 40 is a heating element 70 that heats the water in the reservoir to a preferred nominal temperature range. For coffee, the preferred temperature range is between 195° F. and 205° F. The heating element 70 can be a resistive heating element that experiences an electrical current therein causing the heating element 70 to emit heat due to its electrical resistance. The heating element 70 can be controlled by the controller 60 to activate and deactivate as required to maintain the temperature of the water in the reservoir at the designated value. The controller monitors the temperature of the water in the reservoir 40 via a temperature sensor or probe 75 located inside the reservoir so as to be exposed to the water. The temperature sensor 75 is connected to the controller by a cable 80 so that feedback can be readily measured and communicated to the controller 60. The probe 75 may be a resistor-type probe where the temperature is determined by the resistance of the probe, which varies with temperature. For example, a resistance of 7.6 K Ohms can correspond to a temperature of 205° F., the upper limit of the nominal temperature range for the water in the reservoir 40. A resistance of 21.8 K Ohm may correspond to a temperature of 155° F., a value well below the nominal temperature range. By introducing an electrical current through the temperature probe 75 and measuring the resistance, the temperature of the water in the reservoir 40 can be quickly and readily determined.

While the nominal temperature of the water in the reservoir is preferably between 195° F. and 205° F., the temperature of the water in the reservoir can drop below this range immediately after a refilling operation. That is, as water is removed from the reservoir to participate in the brewing operation, fresh cold water is used to replenish the water, either manually or through the automatic filling system described above. As the cold water mixes with the heated water, the bulk temperature of the mixed water is reduced. Eventually, if no subsequent brewing operation takes place, the heating element 70 will actuate when the probe communicates to the controller 60 that the temperature is low, and the heating element 70 will return the water to the nominal preferred temperature range. However, if multiple brewing operations take place in succession before the heating element can return the water to the preferred temperature, the water used for the brewing operation will be lower than the nominal temperature and can drop twenty to thirty degrees or more depending upon the effectiveness of the heating element, the size of the reservoir, and the timing and number of brewing operations.

Water is pumped through a conduit 90 that extends from the reservoir 40 to the spray head 95 positioned above the filter basket 30. The conduit 90 includes a flow control valve 100 for opening and closing the conduit to permit and restrict water from flowing therethrough. When the flow control valve is open, water pumped from the reservoir 40 flows in the direction of the arrows shown in FIG. 1 from the reservoir to the spray head 95, where it is sprayed over the coffee grounds 40 in the filter 35 to brew the coffee. When the flow control valve 100 is closed, the flow is restricted and no water passes the flow control valve 100 to the spray head 95. The flow control valve 100 is actuated by the controller 60 and is connected to the controller 60 by a cable 105. Upon receipt of a command to initiate a brewing operation from a control panel (not shown), the controller first polls the temperature probe to measure the temperature of the water in the reservoir 40. The probe initiates a test to measure the water temperature, and then generates a signal that is communicated back to the controller 60 along cable 80 that includes information on the temperature of the water in the reservoir 40. The controller then accesses a look-up table stored in memory such as that shown in FIG. 4. The look-up table returns a time interval in seconds that is to be deducted from a nominal time interval used to fill the brew basket when the temperature of the water removed from the reservoir is nominal. For example, referring to FIG. 4, if the temperature probe 75 communicates a signal to the controller 60 indicating that the temperature of the water in the reservoir is 202° F., then the controller returns a value of zero reflecting no decrease in the standard time interval that the controller utilizes to perform the brewing operation. As another example, if successive brewing operations and the subsequent refilling processes as lowered the bulk temperature of the water in the reservoir to 193° F., when the controller 60 references the look-up table the look-up table would return a value of “six seconds.” The value of the time interval returned from the look-up table is then subtracted from the nominal time value stored in the memory of the controller 60.

After the controller 60 has polled the temperature probe 75 and referenced the look-up table for a delta time interval, the controller 60 will actuate the pump and open the flow control valve 100. Concurrently, the controller 60 will initiate the timer for timing the flow control valve open condition. Under nominal conditions, for example, the valve may be opened for ninety seconds. If the temperature of the water is measured to be 202° F. as in the first example, the controller 60 will close the valve 100 exactly ninety seconds after it is first opened corresponding to a zero delta from the nominal time interval, as reflected in the value of zero returned from the look-up table in FIG. 4. However, if the measured temperature of the water is 193° F. as in the second example, the controller will subtract six seconds from the nominal ninety second time interval and close the valve 100 exactly eighty-four seconds after it is opened. The eighty-four seconds reflects a six second reduction in the opening of the flow control valve corresponding to the value returned from the look-up table of FIG. 4 for a temperature of 193° F. Colder water will result in longer delta values, and thus shorter valve openings to account for the higher flow rates of the colder water.

Water from the reservoir 40 is thus pumped through the conduit 90 and past the flow control valve 100 to the spray head 95, where it exits the spray head 95 and is mixed with the coffee grounds in the filter basket 30. The controller 60 senses when the timer has measured the proper time period and, after deducting any delta from the look-up table, it will send a signal via cable 105 to the flow control valve 100 to close and deactivate the pump. The water ceases to flow from the reservoir 40 to the brewing basket 30, and the water in the brew basket will wet the coffee grounds to release the flavored volatiles and oils that mix with the heated water. The water, flavored volatiles, and oils will then pass under the force of gravity through the filter 35 to be collected in the decanter 20 from where it can be served. The decanter can also be of a satellite-type known in the industry that can be removed from a station on the brewing apparatus and placed elsewhere for convenient dispensing of the coffee.

If the brewing operation is repeated, water will be needed to replace the water in the reservoir used for the brewing operation. As cooler water is added to the reservoir, subsequent brewing operations are affected by the change in temperature which are accounted for by the present invention.

FIG. 3 is a flow chart of the steps performed in the determination of the interval for opening the flow control valve. First, the controller receives a command from a control panel to begin a brewing operation in step 200. The controller then commands the temperature probe to measure the reservoir water temperature in step 205, and the probe returns the temperature in step 210. In the next step 215, the controller accesses the look-up table for the time adjustment based on the temperature of the water, and the look-up table returns the time value in step 220. Finally, the controller operates the flow control valve that communicates water from the reservoir to the brewing station in the final step 225 based on the value returned from the look-up table and the nominal time interval.

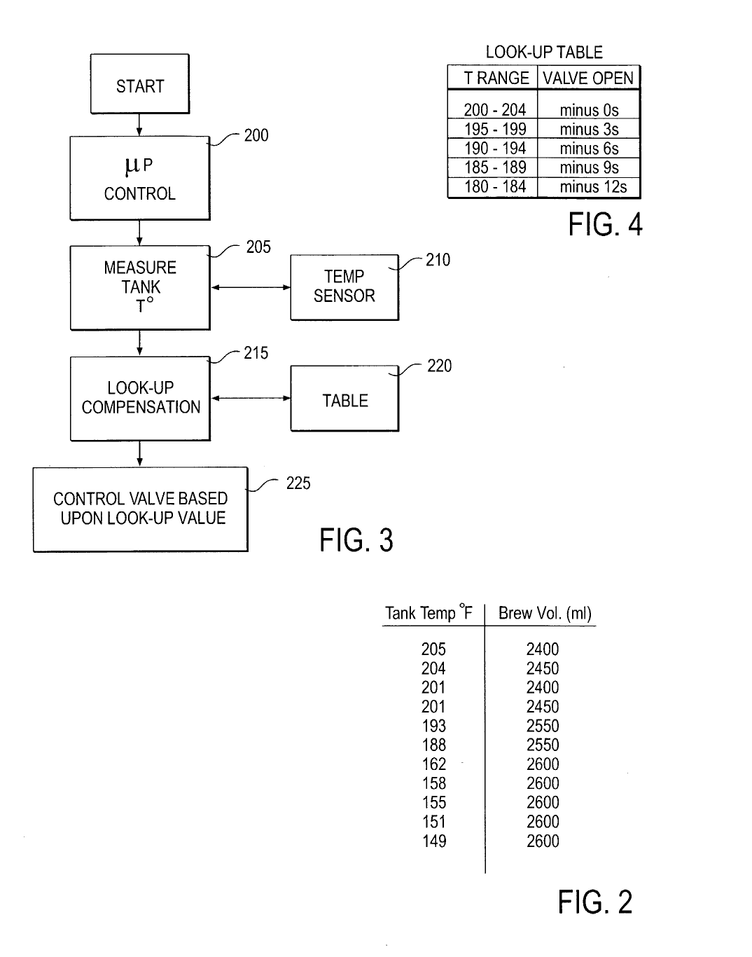

FIG. 2 shows the volumetric changes in the water delivered to the brewing station for different temperatures during a set time period. As shown in FIG. 2, an additional 200 ml of water can be introduced to the brewing station simply due to the temperature fluctuation. This additional 200 ml can lead to overflow, diluted coffee, and poor or inconsistent results in the brewing operation.

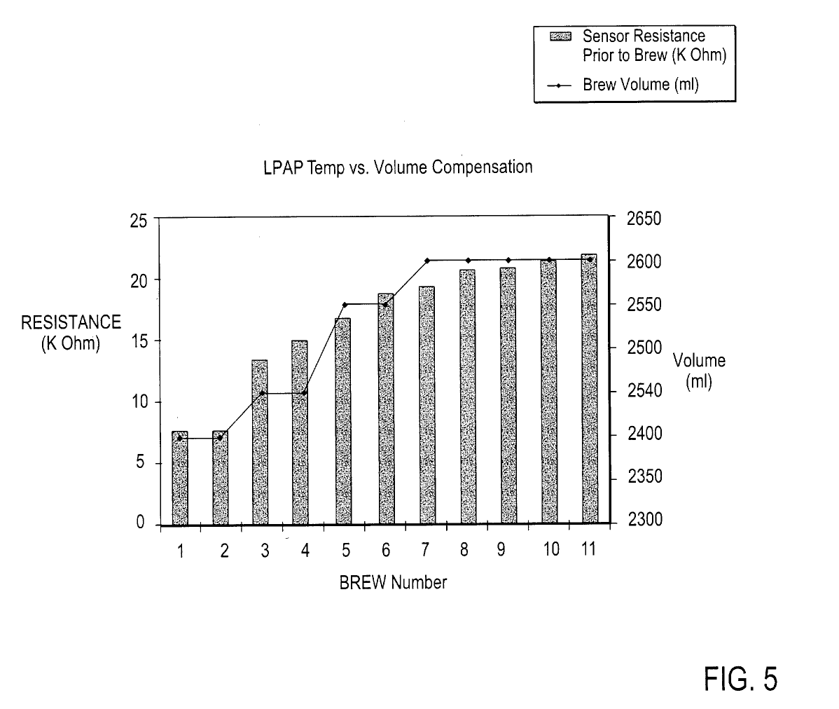

FIG. 5 shows graphically how the decrease in water temperature, as measured by an increase in resistance in the sensor, leads to a higher volume of water introduced to the brewing station for a constant valve opening. However, by implementing a system such as the one described herein, the volume of water to the brewing station can be accurately controlled, resulting in a more consistent and predictable brewing operation.

The present invention illustrates a first system for controlling the volume of water delivered from the reservoir to the brewing compartment using a selected period for opening and closing the flow control valve based on empirical data, calculation, or other estimation methods. However, it should be recognized that the control of the water volume delivered to the brewing compartment can take other forms without departing from the present invention. For example, the flow control valve may have multiple orifices with varying sizes that can be selectively chosen by the controller based upon the temperature readings. The orifice size will determine how much water is pumped through the flow control valve for a given time period and pressure. Alternatively, the pump pressure can be altered on a variable-pressure pump to control the water passing through the flow control valve. These and other known methods for controlling the volume of water can be incorporated into the present invention and should be considered within the scope of the present invention.

Those of skill in the art will recognize that many variations of the present invention can be practiced without departing from the spirit and scope of the present invention. The foregoing description provides the inventor's best mode for carrying out his invention, but should be interpreted as illustrative rather than limiting in its scope. The scope of the invention should not be construed as limited by any specific embodiment detailed in the description of the invention, but rather the scope of the invention should be delimited only by the appended claims below.

What is claimed is:

1. A brewing apparatus comprising:
a reservoir for holding a reserve of heated infusing liquid, said reservoir cooperating with a heating element to warm the heated infusion liquid in the reservoir to a predetermined temperature, said reservoir further comprising a temperature probe for measuring the temperature of the heated infusing liquid in the reservoir and sending a signal corresponding to the measured temperature;
a brewing compartment;
a fluid communication system operative to communicate a quantity of the heated infusing liquid from the reservoir to the brewing compartment, said fluid communication system including piping connecting the reservoir to the brewing compartment, and a flow control valve for regulating the flow of heated infusion liquid flowing from the reservoir to the brewing compartment; and
a controller in communication with the temperature probe and the flow control valve, said controller opening and closing said flow control valve, and including a timer for timing a period between the opening of the flow control valve by the controller and the closing of the flow control valve by the controller, the period selected by the controller based on the signal received from the temperature probe to control the volume of water delivered to the brewing compartment.

2. The brewing apparatus of claim 1 wherein the fluid communication system further comprises a pump for pumping heated infusion liquid from the reservoir to the brewing compartment.

3. The brewing apparatus of claim 2 wherein the reservoir further comprises a fluid level sensor for determining whether a fluid in the reservoir is currently of a below a predetermined level, and a refill valve openable to a supply of infusion liquid for introducing infusing liquid into the reservoir until said fluid level sensor determines that the fluid level achieves said predetermined level.

4. The brewing apparatus of claim 2 wherein the controller accesses a look-up table upon receipt of the temperature probe signal for acquiring a time interval to deduct from a standard time period for opening the flow control valve.

5. The brewing apparatus of claim 4 wherein the temperature probe determines the temperature of the fluid in the reservoir based on an electrical resistance of the probe.

6. The brewing apparatus of claim 5 wherein the resistance of the temperature probe varies between approximately 7.6 K Ohms and 21.8 K Ohms.

7. The brewing apparatus of claim 6 wherein the 7.6 K Ohm resistance corresponds to a flow volume of 2400 ml and the 21.8 K Ohm resistance corresponds to a flow volume of 2600 ml.

8. The brewing apparatus of claim 6 wherein the 7.6 K Ohm resistance of the temperature probe corresponds approximately to a reservoir fluid temperature of approximately 205° F., and the 21.8 K Ohm resistance corresponds approximately to a reservoir fluid temperature of approximately 155° F.

9. A brewing apparatus comprising:
a reservoir for holding a reserve of water, said reservoir cooperating with a heating element to maintain a temperature of the water in the reservoir at a predetermined value, said reservoir further comprising a temperature probe for measuring the temperature of the water in the reservoir and sending a signal corresponding to the measured temperature;
a reservoir refilling system for replenishing the water in the reservoir from a water supply when a water level in the reservoir falls below a predetermined level;
a brewing compartment spaced from the reservoir, the brewing compartment adapted to retain a filter and a quantity of coffee granules;
a fluid communication system operative to communicate a quantity of the heated infusing liquid from the reservoir to the brewing compartment, said fluid communication system including a pump, piping connecting the reservoir to the brewing compartment, and a flow control valve for regulating the flow of heated infusion liquid pumped from the reservoir to the brewing compartment; and
a controller in communication with the temperature probe on the reservoir for receiving the temperature signals therefrom, and further in communication with the flow control valve for actuating the flow control valve based on a temperature signal received from the temperature probe, the actuation of the flow control valve between an open and closed position timed by said controller based upon a predetermined time interval selected based upon said temperature probe signal.

10. The brewing apparatus of claim 9 wherein the controller accesses a look-up table upon receipt of the temperature probe signal for acquiring a time interval to deduct from a standard time period for opening the flow control valve.

11. The brewing apparatus of claim 9 wherein the temperature probe determines the temperature of the water in the reservoir based on an electrical resistance of the probe.

12. The brewing apparatus of claim 11 wherein the resistance of the temperature probe varies between approximately 7.6 K Ohms and 21.8 K Ohms.

13. The brewing apparatus of claim 12 wherein the 7.6 K Ohm resistance corresponds to a flow volume of 2400 ml and the 21.8 K Ohm resistance corresponds to a flow volume of 2600 ml.

14. A brewing apparatus comprising:
a reservoir for holding a reserve of heated water, including an associated heater for heating the water and temperature sensing means for measuring the temperature of the water and sending a signal corresponding to the measured temperature;
a brewing compartment;
a fluid delivery system communicating water from the reservoir to the brewing compartment, the delivery system including piping connecting the reservoir to the brew compartment, means for transporting the water through the piping, and flow control means interposed in the piping for regulating the flow of water through the piping; and
means for receiving the signal from the temperature sensing means and manipulating the flow control means based on the received temperature signal to control the volume of water delivered from the reservoir to the brew compartment.

15. A method for controlling the volume of water delivered to a brew compartment comprising the steps of:
providing a heated reservoir from which to draw water for brewing;
providing a piping system for communicating water from the reservoir to the brew compartment;
providing a flow control valve in the piping system for initiating and terminating flow of water through the piping system;
measuring a temperature of the water in the heated reservoir upon receiving a command to begin a brewing operation and communicating the measured temperature of the heated reservoir to a controller;
adjusting a standard time interval for initiating and terminating flow of water through the piping system based upon the measured temperature of the water in the heated reservoir; and
applying the adjusted time interval to the flow control valve to vary the initiation and termination of the flow of water from the reservoir to the brew compartment based upon the measured temperature of the water in the heated reservoir.
